(19) United States
(12) Patent Application Publication
(10) Pub. No.: US 2026/0021781 A1
(43) Pub. Date: Jan. 22, 2026

(54) METHOD, INFORMATION PROCESSING APPARATUS, AND SYSTEM

(71) Applicant: TOYOTA JIDOSHA KABUSHIKI KAISHA, Toyota-shi (JP)

(72) Inventors: Hirokazu KANO, Nagoya-shi, (JP); Takashi FUJIWARA, Nagakute-shi (JP); Takahiro TSUCHIYA, Toyota-shi (JP)

(73) Assignee: TOYOTA JIDOSHA KABUSHIKI KAISHA, Toyota-shi (JP)

(21) Appl. No.: 19/213,300

(22) Filed: May 20, 2025

(30) Foreign Application Priority Data
Jul. 18, 2024 (JP) 2024-115144

(51) Int. Cl. B60R 16/037; G06F 40/40

(52) U.S. Cl. CPC B60R 16/037; G06F 40/40

(57) ABSTRACT

An information processing apparatus detects, based on vehicle information acquired from a vehicle, the occurrence of any of one or more events. The information processing apparatus then acquires user information and prompt generation information corresponding to the detected event. The information processing apparatus then generates, using the acquired user information and the acquired prompt generation information, a prompt to cause a language model server to output an action against the detected event. The information processing apparatus then inputs the prompt to the language model server. The information processing apparatus then executes the action based on output of the language model server in response to the prompt.

### CROSS-REFERENCE TO RELATED APPLICATION

This application claims priority to Japanese Patent Application No. 2024-115144, filed on Jul. 18, 2024, the entire contents of which are incorporated herein by reference.

### TECHNICAL FIELD

The present disclosure relates to a method, an information processing apparatus, and a system.

### BACKGROUND

Technology for providing user-specific driving environment is known. For example, Patent Literature (PTL) 1 discloses an invention in which a vehicle-related action is performed for each user in a vehicle.

### CITATION LIST

### Patent Literature

PTL 1: JP 2023-055148 A

### SUMMARY

There is room for improvement with respect to technology for providing user-specific driving environment.

It would be helpful to improve technology for providing user-specific driving environment.

A method according to an embodiment of the present disclosure is a method performed by an information processing apparatus, the method including:
detecting, based on vehicle information acquired from a vehicle, the occurrence of any of one or more events;
acquiring user information and prompt generation information corresponding to the detected event;
generating, using the acquired user information and the acquired prompt generation information, a prompt to cause a first language model to output an action against the detected event;
inputting the prompt to the first language model; and
executing the action based on output of the first language model in response to the prompt.

An information processing apparatus according to an embodiment of the present disclosure includes a controller configured to:
detect, based on vehicle information acquired from a vehicle, the occurrence of any of one or more events;
acquire user information and prompt generation information corresponding to the detected event;
generate, using the acquired user information and the acquired prompt generation information, a prompt to cause a first language model to output an action against the detected event;
input the prompt to the first language model; and
execute the action based on output of the first language model in response to the prompt.

A system according to an embodiment of the present disclosure is a system including:
an information processing apparatus; and
a language model server configured to store a first language model,
wherein
the information processing apparatus is configured to:
   detect, based on vehicle information acquired from a vehicle, the occurrence of any of one or more events;
   acquire user information and prompt generation information corresponding to the detected event;
   generate, using the acquired user information and the acquired prompt generation information, a prompt to cause the first language model to output an action against the detected event; and
   input the prompt to the first language model,
the language model server is configured to execute output from the first language model in response to the prompt, and
the information processing apparatus is configured to execute the action based on the output.

According to an embodiment of the present disclosure, technology for providing user-specific driving environment is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus; and

FIG. 3 is a flowchart illustrating operations of the information processing apparatus.

### DETAILED DESCRIPTION

Hereinafter, an embodiment of the present disclosure will be described.

### Outline of Embodiment

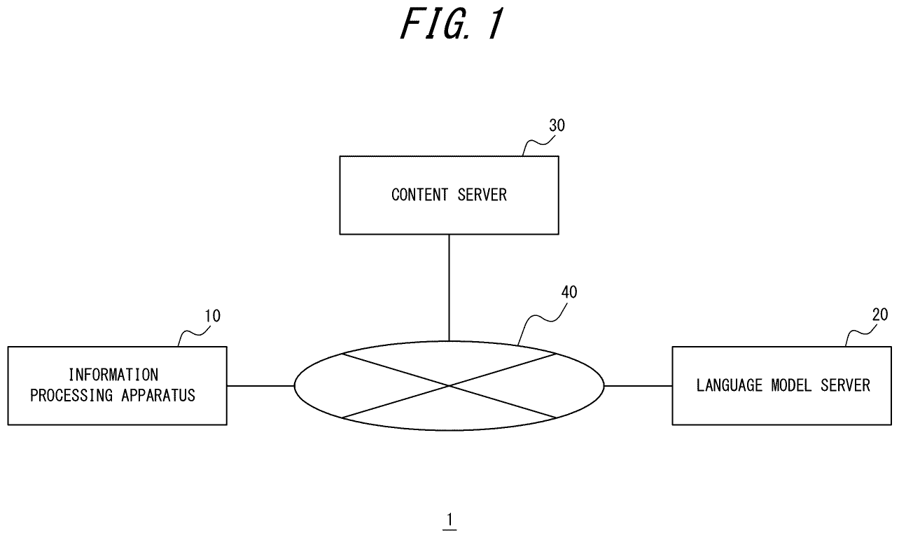

An outline of a system 1 according to the embodiment of the present disclosure will be described with reference to FIG. 1. The system 1 includes an information processing apparatus 10, a language model server 20, and a content server 30. The information processing apparatus 10, the language model server 20, and the content server 30 are communicably connected to a network 40 including, for example, the Internet, a mobile communication network, and the like.

The information processing apparatus 10 is, for example, an in-vehicle apparatus installed in a vehicle, or a server that provides instructions to the vehicle via the network 40. The information processing apparatus 10 can communicate with the language model server 20 and the content server 30 via the network 40.

The language model server 20 is a server that exists in a cloud, for example, and that provides a first language model. The first language model is a large language model (LLM) such as Chatgpt or Megatron-Turing Natural Language Generation (MT-NLG), but is not limited to these and any language model may be used. The language model server 20 receives prompts that are input from the information processing apparatus 10 via the network 40, and transmits, to the information processing apparatus 10, output in response to the prompts. The language model server 20 may also be the information processing apparatus 10.

The content server 30 is a server that provides users with contents, e.g., music, video, and the like. The content server 30 is a streaming service such as YouTube® (YouTube is a registered trademark in Japan, other countries, or both), TikTok, Netflix, or Spotify, but is not limited to these and any streaming services may be used. The information processing apparatus 10 may also play the role of the content server 30.

First, an outline of the present embodiment will be described, and details thereof will be described later. The information processing apparatus 10 detects, based on vehicle information acquired from the vehicle, the occurrence of any of one or more events. The information processing apparatus 10 then acquires user information and prompt generation information corresponding to the detected event. The information processing apparatus 10 then generates, using the acquired user information and the acquired prompt generation information, a prompt to cause the language model server 20 to output an action against the detected event. The information processing apparatus 10 then inputs the prompt to the language model server 20. The information processing apparatus 10 then executes the action based on output of the language model server 20 in response to the prompt.

Technology for providing user-specific driving environment conventionally executes uniform actions. It is difficult for the conventional technology to provide the user-specific driving environment by taking into account various factors such as conditions of users and driving situations. In contrast, according to the present embodiment, the prompt, which is generated using the user information and the prompt generation information corresponding to the detected event, is input to the first language model, and the action based on the output of the first language model in response to the prompt is executed. Therefore, for example, when a child, as an occupant of a vehicle, has started crying, the probability of executing an action, such as playing popular video of the child's favorite contents, that takes into account the conditions, characteristics, preferences, or the like of users against the event that has occurred, is increased. Therefore, according to the present embodiment, the technology for providing the user-specific driving environment is improved in terms of the increased probability of executing actions that take into account the conditions, characteristics, preferences, or the like of users, against events that have occurred.

Next, configurations of the system 1 will be described in detail.

### Configuration of Information Processing Apparatus

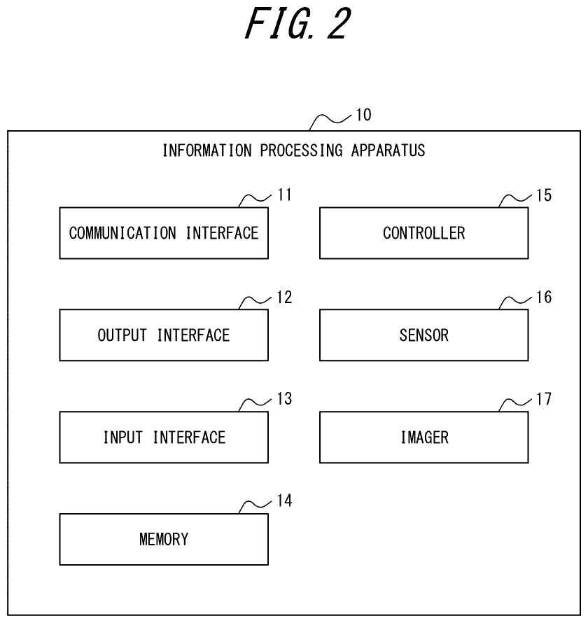

As illustrated in FIG. 2, the information processing apparatus 10 includes a communication interface 11, an output interface 12, an input interface 13, a memory 14, a controller 15, a sensor 16, and an imager 17. In the present embodiment, the information processing apparatus 10 may be constituted of an in-vehicle apparatus and a server that provides instructions to the vehicle. For example, the output interface 12, the input interface 13, the sensor 16, and the imager 17 of the information processing apparatus 10 may be provided in the in-vehicle apparatus, and the memory 14 and the controller 15 may be provided in the server.

The communication interface 11 includes at least one communication interface for connecting to the network 40. The communication interface is compliant with, for example, but not limited to, a mobile communication standard, a wired local area network (LAN) standard, or a wireless LAN standard, and may be compliant with any appropriate communication standard. In the present embodiment, the information processing apparatus 10 communicates with the language model server 20 and the content server 30 via the communication interface 11 and the network 40.

The output interface 12 includes at least one output device that is installed in the vehicle to output information. The output device is, for example, a display for outputting information as video, a speaker for outputting information as audio, or the like, but is not limited to these. Alternatively, the output interface 12 may include an interface for connecting to an external output device.

The input interface 13 includes at least one input device that is installed in the vehicle to detect an input operation by a user. The input device is, for example, a physical key, a capacitive key, a mouse, a touch panel, a touch screen integrally provided with a display of the output interface 12, a microphone, or the like, but is not limited to these. Alternatively, the input interface 13 may include an interface for connecting to an external input device. In the present embodiment, the input interface 13 may be used to acquire the user's voice that is necessary to acquire the vehicle information or the user information.

In the present embodiment, the “user” includes not only a driver of the vehicle, but also occupants such as the driver's children and other family members. The occupants may also include pets.

The memory 14 includes one or more memories. The memories included in the memory 14 may each function as, for example, a main memory, an auxiliary memory, or a cache memory. The memory 14 stores any information to be used for operations of the information processing apparatus 10. For example, the memory 14 may store a system program, an application program, embedded software, and the like. In the present embodiment, the memory 14 stores the user information. The memory 14 may be provided in the in-vehicle apparatus or in the server. The in-vehicle apparatus and the server may constitute the entire memory 14. When the information processing apparatus 10 serves as the content server 30, the memory 14 may also store a program and data necessary as the content server 30. The memory 14 may also store a second language model, which is a different language model from the first language model.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls operations of the entire information processing apparatus 10.

The sensor 16 includes multiple sensors such as, for example, a steering angle sensor, an acceleration sensor, a vehicle speed sensor, a position sensor, and a gyro sensor installed in the vehicle that are necessary to acquire the vehicle information. For example, the sensor 16 may be compliant with, for example, a global positioning system (GPS) or the like.

The imager 17 includes one or more cameras that are installed in the vehicle to enable imaging of the surroundings or interior of the vehicle. In the present embodiment, the imager 17 may be used to acquire images of the user that are necessary to acquire the vehicle information or the user information.

### Flow of Operations of Information Processing Apparatus

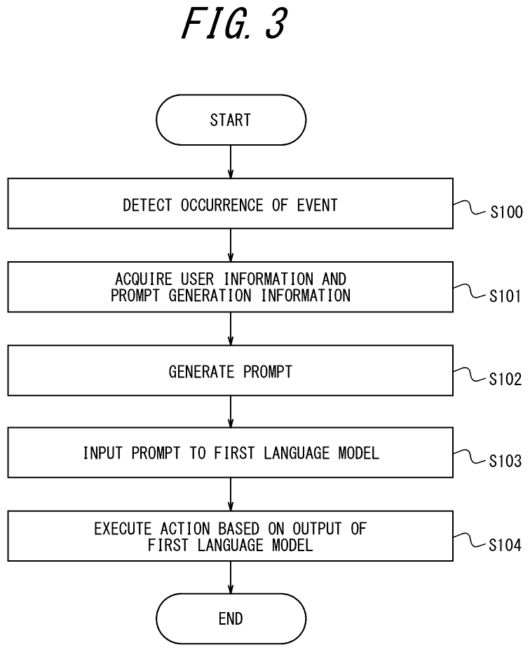

The operations of the information processing apparatus 10 according to the present embodiment will be described with reference to FIG. 3.

S100: The controller 15 of the information processing apparatus 10 detects, based on vehicle information acquired from the vehicle, the occurrence of any of one or more events.

The “one or more events” refer to any one or more events that may occur from the time a user gets on the vehicle until the time the user gets off. The one or more events may include, for example, an occupant (e.g., a child) starting crying, a driver driving blindly, and the driver being fatigued.

The “vehicle information” is any information that can be acquired at predetermined time intervals or in real time using in-vehicle devices such as the input interface 13, the sensor 16, and the imager 17. The vehicle information may include, for example, images and voice of the user, various states (location, speed, shift position, and the like) of the vehicle, route information, and the like. For each of the one or more events, which vehicle information to acquire may be determined in advance.

S101: The controller 15 acquires user information and prompt generation information corresponding to the detected event.

The “user information” may include, for example, but not limited to, the user's condition, schedule, driving history, family structure, age, gender, and preferences, and may also include any information regarding the user. The controller 15 may also acquire the user information with reference to, for example, information managed by another application, such as Microsoft Outlook schedule information. In each of the one or more events, which user information to acquire may be determined in advance.

The “information on the user's condition” may include, for example, but not limited to, the user's current condition such as crying, tired, dazed, or having a cold, or information on the user's health condition such as having a chronic illness, and may also include any information regarding the user's condition.

The “information on the user's schedule” may include, for example, but not limited to, information on the previous day's activities or sleeping hours, and may also include any information indicating the user's activities.

The “information on the user's driving history” may include, for example, but not limited to, information on the user's driving time, destination, and the like on the previous day, and may also include any information indicating the user's driving history. The information on the user's driving history may be a history of any information acquired using in-vehicle devices such as the input interface 13, the sensor 16, and the imager 17.

The “information on the user's family structure” may include information on the user's spouse, children, parents, and the like. The information on the user's family structure may also include information on pets.

The “information on the user's preferences” may include, for example, but not limited to, information on the user's favorite foods, music, and hobbies, and may also include any information regarding the user's preferences. The information on the user's preferences may also include information regarding what the user dislikes. For example, the information on the user's preferences may include information on foods, music, and the like the user dislikes.

The “prompt generation information” may include an instruction to cause output of an action against the event, which is a template for a prompt, and an instruction to take into account the acquired user information in determining the action. The template for the prompt may be stored in advance in the memory 14. Alternatively, the template for the prompt may be created using the second language model stored in the memory 14. Specifically, the controller 15 may input, to the second language model, information on the detected event, and use output from the second language model in response to the input, as the template for the prompt.

S102: The controller 15 generates, using the acquired user information and the acquired prompt generation information, the prompt to cause the language model server 20 to output the action against the detected event.

Specifically, the controller 15 generates the prompt, by embedding the acquired user information in the part of the template of the prompt that takes into account the acquired user information in determining the action. Alternatively, the controller 15 may input, to the second language model, information on the detected event and the acquired user information, and use output from the second language model in response to the input, as the prompt.

S103: The controller 15 inputs the prompt to the language model server 20.

S104: The controller 15 executes the action based on output of the language model server 20 in response to the prompt.

The execution of the “action” means to cause each device of the information processing apparatus 10 or the content server 30 to perform an action corresponding to the output of the language model server 20 in response to the prompt, or output an execution command to each device of the information processing apparatus 10 or the content server 30. The “action” may include, for example, but not limited to, playing specific music, playing specific video, and displaying route guidance to a rest area such as a service area, and may also include any actions that can be executed using each device of the information processing apparatus 10 or the content server 30.

Although the operations of the present embodiment are performed by executing the steps described above, more specific examples are described below to illustrate more specific operations.

A first example in which the event is that a child has started crying is described below. In this case, the vehicle information used in S100 may be images or voice of the child. The controller 15 detects, from the child's images captured by the imager 17, that the child has started crying. Alternatively, the controller 15 may detect the child's cry with a microphone of the input interface 13. Next, in S101, the controller 15 acquires the user information corresponding to the event that the child has started crying, i.e., information on the child's condition, age, gender, and preferences, and the prompt generation information corresponding to the event. Next, when the prompt generation information is, for example, “A child is crying. Please consider and take measures with taking into account the following matters.”, the controller 15 generates the prompt in $102 by adding the information on the child's condition, age, gender, and preferences to the prompt generation information. Next, in S103, the controller 15 inputs the prompt to the language model server 20. At this time, assume that the various information added to the prompt generation information is that the child's condition is crying, the child's age is 5 years old, the child's gender is male, and the child's preference is that he loves cartoon programs. Assume that the output of the language model server 20 in response to the prompt is, for example, “Why don't you play video of children's cartoon program A?” In this case, in S104, the controller 15 may execute the action, by acquiring the video by connecting to the content server 30 or searching the memory 14, and playing the video using a display and a speaker of the output interface 12.

Next, a second example in which the event is that a driver is tired is described below. In this case, the vehicle information used in S100 may be images of the driver, various vehicle states (location, speed, shift position, and the like), and route information. For example, the controller 15 may detect that the driver is tired from movements of the driver's body or eyes in the driver's images captured by the imager 17 or from the various vehicle states acquired by the sensor 16. Next, in S101, the controller 15 acquires the user information corresponding to the event that the driver is tired, i.e., information on the driver's schedule and driving history, and the prompt generation information corresponding to the event. Next, when the prompt generation information is, for example, “A driver is tired. With taking into account the following matters, please let the driver continue driving without taking a break, or when the driver should take a break, please provide location information on a break point.”, the controller 15 generates the prompt in S102 by adding, to the prompt generation information, the information on the driver's schedule and driving history, and the location of the vehicle and the route information included in the vehicle information. Next, in S103, the controller 15 inputs the prompt to the language model server 20. At this time, assume that the various information added to the prompt generation information is that the driver's schedule is 3 hours of sleep yesterday, the driver's driving history is round-trip driving from Tokyo to

Osaka yesterday, the location of the vehicle is Hachioji, and the route information is a route to Nagoya with a remaining distance of 340 km. Assume that the output of the language model server 20 in response to the prompt is, for example, location information for the Ishikawa parking area. In this case, the controller 15 may execute the action in S104 by displaying a route from the vehicle's current location to the Ishikawa parking area on a display of the output interface 12. The controller 15 may also output, using a speaker of the output interface 12, audio suggesting the driver to rest in the parking area.

Alternatively, assume that the various information added to the prompt generation information is that the driver's schedule is 7 hours of sleep yesterday, the driver's driving history is no driving history yesterday, the location of the vehicle is Hachioji, and the route information is a route to Mt. Takao with a remaining distance of 7 km. Assume that the output of the language model server 20 in response to the prompt is, for example, that it is okay to let the driver continue driving without taking a break, but that the driver needs to be provided with a caution. In this case, the controller 15 may execute the action in S104 using a display or a speaker of the output interface 12 by displaying a message or outputting audio that alerts the driver to the lack of concentration while driving.

As described above, the information processing apparatus 10 according to the present embodiment detects the occurrence of any of one or more events based on vehicle information acquired from the vehicle. The information processing apparatus 10 then acquires user information and prompt generation information corresponding to the detected event. The information processing apparatus 10 then generates, using the acquired user information and the acquired prompt generation information, a prompt to cause the language model server 20 to output an action against the detected event. The information processing apparatus 10 then inputs the prompt to the language model server 20. The information processing apparatus 10 then executes the action based on output of the language model server 20 in response to the prompt.

According to such a configuration, the prompt, which is generated using the user information and the prompt generation information corresponding to the detected event, is input to the first language model, and the action based on the output of the first language model in response to the prompt is executed. Therefore, for example, when a child, as an occupant of a vehicle, has started crying, the probability of executing an action, such as playing popular video of the child's favorite contents, that takes into account the conditions, characteristics, preferences, or the like of users against the event that has occurred, is increased. Therefore, according to the present embodiment, the technology for providing the user-specific driving environment is improved in terms of the increased probability of executing actions that take into account the conditions, characteristics, preferences, or the like of users, against events that have occurred.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, an embodiment in which the configuration and operations of the information processing apparatus 10 in the above embodiment are distributed to multiple computers capable of communicating with each other can be implemented.

For example, in the embodiment described above, the controller 15 may acquire the user's reaction to the action executed in S104. In this case, the controller 15 may also update the user information based on the user's reaction.

Specifically, the controller 15 acquires, using any device of the information processing apparatus 10, an environmental change in the vehicle related to the user's reaction after executing S104. For example, assume that the event is the first example described above. In this case, after S104, the controller 15 acquires any environmental change because of which the child's reaction is considered to be negative, including, for example, but not limited to, whether the child has stopped crying, whether the driver or occupant has muted the volume of the speaker, whether the driver or occupant has stopped playing the video, or the like. When the environmental change because of which the child's reaction is considered to be negative is acquired, the controller 15 may update the information on the child's preferences stored in the memory 14 with information indicating that the cartoon program A is not a preference. On the other hand, when no environmental change because of which the child's reaction is considered to be negative is acquired, the controller 15 may update the information on the child's preferences stored in the memory 14 with information indicating that the cartoon program A is a preference.

For example, in the variation described above, when the user's reaction is negative, the controller 15 may generate a prompt in S102, further using the user's reaction, and execute S103 and S104 again.

For example, assume that the event is the first example described above, and an environmental change that is considered to be negative is acquired. In this case, the controller 15 may generate, in S102, a prompt by further adding, to the prompt generation information, that the child's condition is crying, the child's age is 5 years old, the child's gender is male, and the child's preference is not only that he loves cartoon programs but also that the cartoon program A is not a preference. Alternatively, the controller 15 may generate a prompt that includes an instruction to output an alternative because the cartoon program A is not a preference.

For example, in the embodiment described above, each of the one or more events may include a priority level. When two or more events of the one or more events have occurred simultaneously, the controller 15 may generate a prompt based further on the priority level of each of the two or more events.

For example, assume that the first and second examples described above have occurred simultaneously, and the second example has a higher priority level than the first example. In this case, the controller 15 may give a priority to the event in the second example to execute processing.

For example, the priority level may be in numerical form using integers in any range, such as 5 to 1, in descending order of the priority level. For example, the priority level may be in alphabetical rank format, such as S, A, B, C, and D in descending order of the priority level, rather than in the numerical form, or may be text such as “high,” “medium,” and “low.” The priority level may be changeable.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of the general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A method performed by an information processing apparatus, the method comprising:
detecting, based on vehicle information acquired from a vehicle, an occurrence of any of one or more events;
acquiring user information and prompt generation information corresponding to the detected event;
generating, using the acquired user information and the acquired prompt generation information, a prompt to cause a first language model to output an action against the detected event;
inputting the prompt to the first language model; and
executing the action based on output of the first language model in response to the prompt.

[Appendix 2] The method according to appendix 1, further comprising creating, using a second language model stored in the information processing apparatus, the prompt generation information corresponding to the detected event. [Appendix 3] The method according to appendix 1 or 2, wherein the vehicle information includes an image of a user, voice of the user, a state of the vehicle, and route information on the vehicle. [Appendix 4] The method according to any one of appendices 1 to 3, wherein the action includes:
playing specific music;
playing specific video; and
displaying route guidance to a rest area.

[Appendix 5] The method according to any one of appendices 1 to 4, further comprising:
acquiring a reaction of a user to the action performed; and
updating the user information based on the reaction of the user. [Appendix 6] The method according to any one of appendices 1 to 5, further comprising acquiring a reaction of a user to the action performed,
wherein when the reaction of the user is negative, the information processing apparatus is configured to generate the prompt further using the reaction of the user.

[Appendix 7] The method according to any one of appendices 1 to 6, wherein
each of the one or more events includes a priority level, and
when two or more events of the one or more events have occurred simultaneously, the information processing apparatus is configured to generate the prompt based further on the priority level of each of the two or more events.

[Appendix 8] An information processing apparatus comprising a controller configured to:
detect, based on vehicle information acquired from a vehicle, an occurrence of any of one or more events;
acquire user information and prompt generation information corresponding to the detected event;
generate, using the acquired user information and the acquired prompt generation information, a prompt to cause a first language model to output an action against the detected event;
input the prompt to the first language model; and execute the action based on output of the first language model in response to the prompt.

[Appendix 9] The information processing apparatus according to appendix 8, further comprising a memory configured to store a second language model,
wherein the controller is configured to create, using the second language model, the prompt generation information corresponding to the detected event.

[Appendix 10] The information processing apparatus according to appendix 8 or 9, wherein the vehicle information includes an image of a user, voice of the user, a state of the vehicle, and route information on the vehicle.

[Appendix 11] The information processing apparatus according to any one of appendices 8 to 10, wherein the action includes:
playing specific music;
playing specific video; and
displaying route guidance to a rest area.

[Appendix 12] The information processing apparatus according to any one of appendices 8 to 11, wherein the controller is further configured to:
acquire a reaction of a user to the action performed; and
update the user information based on the reaction of the user.

[Appendix 13] The information processing apparatus according to any one of appendices 8 to 12, wherein the controller is configured to:
acquire a reaction of a user to the action performed; and
when the reaction of the user is negative, generate, further using the reaction of the user, the prompt to cause the first language model to output the action against the detected event.

[Appendix 14] The information processing apparatus according to any one of appendices 8 to 13, wherein
each of the one or more events includes a priority level, and
when two or more events of the one or more events have occurred simultaneously, the controller is configured to generate the prompt based further on the priority level of each of the two or more events. [Appendix 15] A system comprising:
an information processing apparatus; and
a language model server configured to store a first language model,
wherein
the information processing apparatus is configured to:
   detect, based on vehicle information acquired from a vehicle, an occurrence of any of one or more events;
   acquire user information and prompt generation information corresponding to the detected event;
   generate, using the acquired user information and the acquired prompt generation information, a prompt to cause the first language model to output an action against the detected event; and
   input the prompt to the first language model,
the language model server is configured to execute output from the first language model in response to the prompt, and
the information processing apparatus is configured to execute the action based on the output.

[Appendix 16] The system according to appendix 15, wherein the information processing apparatus is configured to create, using a second language model stored in the information processing apparatus, the prompt generation information corresponding to the detected event.

[Appendix 17] The system according to appendix 15 or 16, wherein the vehicle information includes an image of a user, voice of the user, a state of the vehicle, and route information on the vehicle.

[Appendix 18] The system according to any one of appendices 15 to 17, wherein the action includes:
playing specific music;
playing specific video; and
displaying route guidance to a rest area.

[Appendix 19] The system according to any one of appendices 15 to 18, wherein the information processing apparatus is configured to:
acquire a reaction of a user to the action performed; and
update the user information based on the reaction of the user. [Appendix 20] The system according to any one of appendices 15 to 19, wherein the information processing apparatus is configured to:
acquire a reaction of a user to the action performed; and
when the reaction of the user is negative, generate, further using the reaction of the user, the prompt to cause the first language model to output the action against the detected event.

1. A method performed by an information processing apparatus, the method comprising:
detecting, based on vehicle information acquired from a vehicle, an occurrence of any of one or more events;
acquiring user information and prompt generation information corresponding to the detected event;
generating, using the acquired user information and the acquired prompt generation information, a prompt to cause a first language model to output an action against the detected event;
inputting the prompt to the first language model; and
executing the action based on output of the first language model in response to the prompt.

2. The method according to claim 1, further comprising creating, using a second language model stored in the information processing apparatus, the prompt generation information corresponding to the detected event.

3. The method according to claim 1, wherein the vehicle information includes an image of a user, voice of the user, a state of the vehicle, and route information on the vehicle.

4. The method according to claim 1, wherein the action includes:
playing specific music;
playing specific video; and
displaying route guidance to a rest area.

5. The method according to claim 1, further comprising:
acquiring a reaction of a user to the action performed; and
updating the user information based on the reaction of the user.

6. The method according to claim 1, further comprising acquiring a reaction of a user to the action performed,
wherein when the reaction of the user is negative, the information processing apparatus is configured to generate the prompt further using the reaction of the user.

7. The method according to claim 1, wherein
each of the one or more events includes a priority level, and
when two or more events of the one or more events have occurred simultaneously, the information processing apparatus is configured to generate the prompt based further on the priority level of each of the two or more events.

8. An information processing apparatus comprising a controller configured to:
detect, based on vehicle information acquired from a vehicle, an occurrence of any of one or more events;
acquire user information and prompt generation information corresponding to the detected event;
generate, using the acquired user information and the acquired prompt generation information, a prompt to cause a first language model to output an action against the detected event;
input the prompt to the first language model; and
execute the action based on output of the first language model in response to the prompt.

9. The information processing apparatus according to claim 8, further comprising a memory configured to store a second language model,
wherein the controller is configured to create, using the second language model, the prompt generation information corresponding to the detected event.

10. The information processing apparatus according to claim 8, wherein the vehicle information includes an image of a user, voice of the user, a state of the vehicle, and route information on the vehicle.

11. The information processing apparatus according to claim 8, wherein the action includes:
playing specific music;
playing specific video; and
displaying route guidance to a rest area.

12. The information processing apparatus according to claim 8, wherein the controller is further configured to:
acquire a reaction of a user to the action performed; and
update the user information based on the reaction of the user.

13. The information processing apparatus according to claim 8, wherein the controller is configured to:
acquire a reaction of a user to the action performed; and
when the reaction of the user is negative, generate, further using the reaction of the user, the prompt to cause the first language model to output the action against the detected event.

14. The information processing apparatus according to claim 8, wherein
each of the one or more events includes a priority level, and
when two or more events of the one or more events have occurred simultaneously, the controller is configured to generate the prompt based further on the priority level of each of the two or more events.

15. A system comprising:
an information processing apparatus; and
a language model server configured to store a first language model,
wherein
the information processing apparatus is configured to:
detect, based on vehicle information acquired from a vehicle, an occurrence of any of one or more events;
acquire user information and prompt generation information corresponding to the detected event;
generate, using the acquired user information and the acquired prompt generation information, a prompt to cause the first language model to output an action against the detected event; and
input the prompt to the first language model,
the language model server is configured to execute output from the first language model in response to the prompt, and
the information processing apparatus is configured to execute the action based on the output.

16. The system according to claim 15, wherein the information processing apparatus is configured to create, using a second language model stored in the information processing apparatus, the prompt generation information corresponding to the detected event.

17. The system according to claim 15, wherein the vehicle information includes an image of a user, voice of the user, a state of the vehicle, and route information on the vehicle.

18. The system according to claim 15, wherein the action includes:
playing specific music;
playing specific video; and
displaying route guidance to a rest area.

19. The system according to claim 15, wherein the information processing apparatus is configured to:
acquire a reaction of a user to the action performed; and
update the user information based on the reaction of the user.

20. The system according to claim 15, wherein the information processing apparatus is configured to:
acquire a reaction of a user to the action performed; and
when the reaction of the user is negative, generate, further using the reaction of the user, the prompt to cause the first language model to output the action against the detected event.
